(19) United States
(12) Patent Application Publication
(10) Pub. No.: US 2010/0180672 A1
(43) Pub. Date: Jul. 22, 2010

(54) Methods for inspecting atmospheric storage tanks above ground and in floating vessels

(76) Inventor: William Thor Zollinger, Idaho Falls, ID (US)

Correspondence Address: KAREN B. TRIPP, ATTORNEY AT LAW, P.O. BOX 1301, HOUSTON, TX, 77251, US

(21) Appl. No.: 12/653,901

(22) Filed: Dec. 21, 2009

Related U.S. Application Data
(60) Provisional application No. 61/203,171, filed on Dec. 20, 2008.

(51) Int. Cl. G01N 15/04; G06F 19/00

(52) U.S. Cl. 73/61.63; 700/245; 700/259; 901/1; 901/46; 901/47

(57) ABSTRACT

Method for safely inspecting an atmospheric storage tank, located above ground or on a floating vessel, without having to empty the tank. The method employs an explosion proof robot whose explosion proof character is assured by explosion proof design and monitoring the pressure within and outside the robot throughout the inspection. Operation of the robot will cease if the pressure within the robot falls below the pressure external the robot.

### RELATED APPLICATION

This application claims priority from U.S. Provisional Patent Application No. 61/203,171, filed Dec. 20, 2008.

### FIELD OF THE INVENTION

The present invention generally relates to methods for inspecting the condition, thickness, and integrity of floors and inside roof seals of atmospheric storage tanks and vessels, particularly while the tank or vessel is in service.

### BACKGROUND OF THE INVENTION

The following paragraphs contain some discussion, which is illuminated by the innovations disclosed in this application, and any discussion of actual or proposed or possible approaches in this Background section does not imply that those approaches are prior art.

Commercial and industrial storage tanks are widely used for storing a great variety of liquids. Some of these liquids are highly corrosive and/or are flammable. The service life of a storage tank will vary, depending upon environmental conditions, including the liquid being stored. Eventually, however, the tank will become corroded and develop leaks. Such leakage can result in a significant danger to the environment and health of nearby residents. For example, above ground storage tanks are commonly used for storing petrochemicals at refineries and chemical plants. Such chemicals are often flammable and even explosive and pose significant health and safety hazards if not properly contained. Federal as well as local regulations govern the structure of such storage tanks as well as their maintenance. American Petroleum Institute (API) 653 provides standards used for many above ground storage tanks.

Periodic inspection of storage tanks is part of routine maintenance. Typically, such inspection has involved taking the tank out of service and emptying the tank to allow actual viewing of the floor, walls and roof of the tank. For this procedure, the tank contents must be transferred to alternative storage facilities such as other tanks or barges. The tank is out of service while it is prepared for the inspection as well as during the inspection, a time that is typically 30 days or more depending on the size of the tank and the level of preparation the tank needs.

Usually, the tank will have sludge and/or sedimentation on the tank bottom that will have to be removed so the tank bottom can be viewed for inspection. Before any such sludge removal or tank inspection, the tank will usually have to be degassed, a slow and expensive process that removes the vapor from the tank interior.

Petrochemical tanks typically will have volatile organic compounds (VOCs) and carbon dioxide in the vapor, which are considered air pollutants, making the removal or degassing the tank more problematic. Many states, including Texas, regulate these vapors. According to air quality regulations, tank owners must handle and dispose of all vapors in a safe manner that often requires costly procedures. Additionally these procedures require “confined space entry,” a highly regulated condition where workers must enter a hazardous environment to clean it. Cleaning a large tank requires thousands of man-hours and generates further hazardous waste.

Robotic inspection of above ground storage tanks has been suggested as a solution to a number of the problems associated with tank inspection. The use of robots would avoid the inherent dangers involved in having a person enter the tank for inspection and would at least theoretically avoid the need to empty the tank or remove sludge from the tank floor. However, in practice, commercially available robots have become mired or stuck in the sludge and have posed a danger for use in many tanks holding volatile, flammable or explosive chemicals by not being explosion proof. Consequently, a need continues to exist for improved methods of inspecting above ground and other atmospheric storage tanks.

### SUMMARY OF THE INVENTION

Some teachings and advantages found in the present application are summarized briefly below. However, note that the present application may disclose multiple embodiments, and not all of the statements in this Summary section necessarily relate to all of those embodiments. Moreover, none of these statements limit the claims in any way.

The present invention provides a method for safely inspecting an atmospheric storage tank, located above ground or in a floating vessel, without having to empty the tank or have a person enter the tank. The method employs one or more explosion proof robots capable of inspecting the tank floor and/or the underside of a floating tank roof. The robots are made explosion proof by explosion proof design, including fittings made from materials that do not produce sparks when struck, and by a purge and pressure system monitored throughout the inspection. If during the inspection the pressure within the robot falls below the pressure outside the robot, operation of the robot, and the inspection, will cease.

When the robot is in operation, the inspection can be accomplished, for example, with sonar using transducers on the robot, and/or using a camera on the robot. Illumination for the camera may be obtained for example with LEDs and/or through a light pipe for example. Brush attachments and/or an inflatable/deflatable float may be used to enhance the maneuverability of the robot and recovery of the robot when the inspection is complete.

### BRIEF DESCRIPTION OF THE DRAWINGS

FIG. 1 is a perspective view of a robot used in the method of the present invention for inspecting atmospheric tank floors.

FIG. 2 is a perspective view of a robot used in the method of the present invention for inspecting the inside of the lower roof seal of an atmospheric tank.

FIG. 3 is an electronics logic diagram for purging and pressurizing the robot according to a preferred embodiment of the method of the present invention.

### DESCRIPTION OF THE PREFERRED EMBODIMENTS

The method of the present invention is directed to enabling inspection of an atmospheric tank, such as an above ground storage tank used for storing, for example, petrochemicals, while the tank is in service. The method may also be used or adapted for inspecting atmospheric tanks in barges or ships. The method enables inspection for detection of corrosion and cracking not only of the tank floor, but also of the inside of the tank roof, and particularly the inside of a lower roof seal.

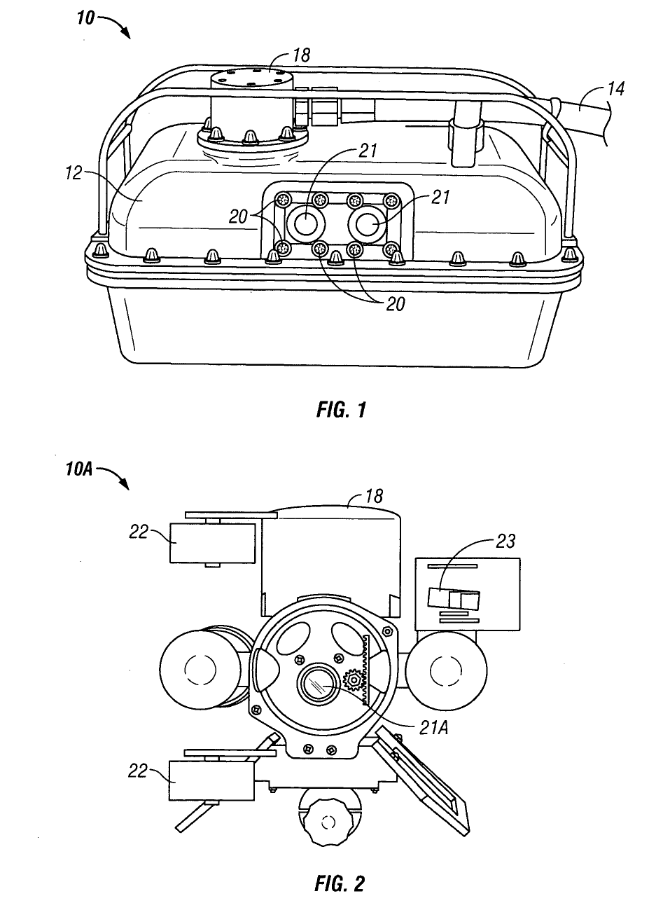

According to the method, and referring to FIGS. 1 and 2, an explosion proof robot 10 or 10A is employed in the tank (not shown) for conducting the inspection. Before entry, the robot is purged multiple times, most preferably about ten times, with inert gas, preferably nitrogen, to remove any and all oxygen from the robot. Upon and after purging, the robot system is pressurized, that is, the inner volume of the robot 10 or 10A has an internal pressure greater than the pressure in the environment external the robot 10 or 10A. Such pressurization in the robot is monitored before and throughout the inspection. So long as the pressurization is stable or is within the robot greater than without the robot, the robot may be powered and used for the inspection.

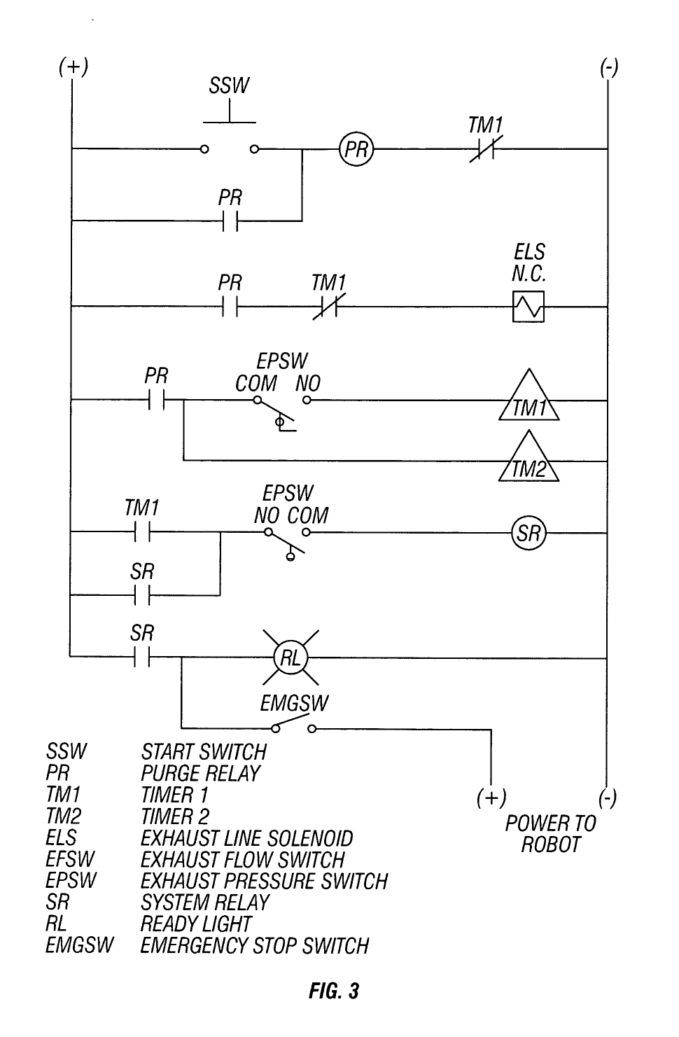

The pressure monitoring of the robot is most preferably conducted electronically and the robot is shut off automatically if the pressure within the robot drops below the external pressure of the robot. Referring to FIG. 3, which is an electronics logic diagram for one embodiment of an automated control system for the robot inspection, pressing a “start” or “on” button initiates the system. Power to the system then supplies 120 vac across the left and rights of the ladder. Operators would manually open the supply valve to the system to supply inert gas, preferably from a bottled gas supply to the robot.

In other words, the first rung of the logic ladder is energized when the Start Switch (SSW) is pressed to begin the purging and pressurization cycle. Pressing the switch sends current through the Purge Relay (PR) which closes the holding relay beneath the Start Switch (SSW) keeping the rung energized after the Start Switch is released. The contacts in the Purge Relay close in the next two rungs down in the ladder, starting the purge cycle.

Current flows through the second rung in the ladder through the closed Timer-1 (TM1) contact, supplying power to the Exhaust Line Solenoid valve (ELS). This valve opens to allow purge gas to flow through the system. At this point, pressure drops temporarily as gas flows through the system, energizing the Exhaust Flow Switch (EFSW). Timer-1 starts its' countdown along with Timer-2, which started counting a moment before TM1. Timer-1 is set to allow ten system volumes of gas to purge the system of oxygen. Timer-2 is set to allow sufficient time after the purge for the system to come up to pressure.

The next rung of the ladder controls the pressurization portion of the cycle. Following a complete purge, Timer-1 times out and closes the TM1 contact in the rung to start pressurization, and opening the TM 1 contact in the second rung to close the Exhaust Valve (EFSW). As soon as the system pressure rises to the set point, the Exhaust Pressure Switch (EPSW) closes, supplying power to the System Relay (SR) which locks itself in by closing the SR contact below the TM1 contact.

Timer-2 completes it's countdown to complete the purge and pressurization cycle. It opens the TM2 contact in rung one, de-energizing the Purge Relay (PR) and de-energizing both timers. The System Relay holds itself closed and supplies power to light the Ready Light (RL). This indicates to the operator that the system is fully purged and pressurized, and that power is available to the robot. If this doesn't happen before the Timer-2 times out, the system resets back to the starting state indicating that a problem has occurred.

Power is available to the robot through the SR contact, through the Emergency Stop Switch (EMGSW) at the bottom of the diagram in FIG. 3. The Emergency Stop Switch allows the operator to control whether the robot actually receives power or not. This prevents the system form automatically turning on the robot, and can be pressed to cut power immediately to the robot in an emergency. If gas pressure is lost, the pressure switches open, de-energizing the System Relay (SR) cutting power to the robot, and the operator will see all of the robot's cameras go off and all motion cease. The system must be re-purged to re-energize the robots.

If main power is lost for any reason to the control system, the system resets back to the beginning state, removing power from the robot. As a backup, the normal state of all valves is de-energized so that the inert gas supply maintains pressure to the robot in the event main power is lost. This ensures that the robot is always pressurized, which is especially important when the robot is submerged in a tank of flammable or explosive liquid such as, for example, petrochemicals or fuel. Such pressurization ensures that any robot housing leakage will result in inert gas exiting the robot rather than the potentially explosive liquid leaking in. Thus, the pressurization ensures that the potentially explosive liquid is kept out of the robot even if the main power is lost. In such an event, the robot is retrieved manually and re-purged before power is or can be restored.

The purging and pressurization of the robot 10 or 10A includes not only the robot housing 12 or 12A, but all related or connected parts, such as, for example, a tether or cabling 14, that are used with the robot during the inspection. That is, in the purging, the inert gas flows though the tether or cabling 14 to the housing 12 or 12A and is routed sequentially through all electronics making up the robot 10 or 10A, and then the inert gas is directed up the tether or cabling 12 or 12A and outside the supply line and electrical cables up to the control box for the robot.

The tether or cabling 14 comprises a cable jacket constructed from fuel transfer lines and fittings, and the fuel transfer lines are constructed with internal conductive wires or meshes, to prevent any static electricity from building up on the outside of the lines. All of the fittings are made from materials that do not produce any sparks when struck, such as brass or aluminum for example. Steel or stainless steel fittings should not be used on a robot to be used in inspections of tanks holding flammable or explosive liquids. Preferably cam-lock connectors are used in between longer runs of cable to allow the cable to be disconnected from the control box and the robot.

The connection of the cabling 14 at the robot should comply with requirements for explosive environments. No electrical connectors with exposed pins should be used. All of the electrical cables and inert gas lines routed through the outer cable jacket exit a “Top Hat” 18 into the robot 10, which is bolted onto the robot housing 12. The “Top Hat” 18 should be comprised of a material that does not spark when struck such as brass or aluminum, for example. A large 0-ring (not shown) provides the seal between the “Top Hat” 18 and the robot housing 12. A set of non-sparking bolts, preferably comprised of bronze, are used to connect and disconnect the “Top Hat” 18 from the robot housing 12. Electrical cables running through the jacket can be connected and disconnected inside the robot housing 12, separate from the cable jacket if desired.

The robot 10 or 10A will preferably have one or more motors for moving the robot inside the tank during the tank inspection. Preferably the motor controllers will be outside the robot housing 12 or 12A and located in the control box (always outside the tank) so as not to cause electrical noise or interfere with the robot's ultrasonic sensors. When the control box operates over 100 feet from the robot, and even as much as 300 feet away, large cabling, such as commonly used for massive power conduction, with a large cross section of copper wiring should be used to reduce or lower the resistance of the cable.

The function of the robot 10 or 10A in the inspection of the method of the invention is to provide a moving platform for the inspection sensors to enable an operator to collect data and/or observe the condition of the tank floor and/or inside lower ceiling or roof seals. Thus, a typical robot for utility in the invention will have inside the housing 12 or 12A, onboard electronics and environmental sensors, a drive system to move the robot as noted above, cameras and lights.

Ultrasonic probes are typically located inside the housing 12 or 12A from where they shoot sound through delay lines, which for robot 10 are typically mounted in the base of the housing 12 across the front of the housing 12. Most sonar transducers are designed with the sensitive crystals embedded in epoxy, which is an inherently safe configuration for use in an explosive environment. The wires come out of the back of the epoxy through a channel in the metal base. A block of data from the transducers may be recorded and processed by a computer. Knowing the speed of sound in the tank liquid, a sound from a specific direction reaches each of the transducers at a different time. By adding the sound from each transducer (delayed by the appropriate amount of time, the sound from that direction can be isolated and amplified. A black and white image could be created by using the amplitude of the sound and with further mathematical processing a colorized image could be created. Such processing could occur in real time or off-line.

Most robots use internally mounted, small, LED light clusters 20 and a camera 21 for visual inspection of tanks. Poor lighting inside tanks, however, makes such viewing difficult, particularly in dark fluids. However, incandescent light, which might provide more light, puts off too much heat for an explosive environment. A black and white camera requires less light than a color camera and is thus preferred. A commercially available light pipe might also be used to capture light from an external source and funnel the illumination down the pipe into the tank. This could be accomplished by inserting the light pipe into the tank through a roof vent line or hatch. A powerful white light could be placed above the light pipe to shine down through it into the tank, or sunlight could be used on a sufficiently bright day. This could be done in multiple holes in the tank top for greater illumination inside the tank and would produce a spectrum of white light, even allowing a viable visual inspection with a color camera. The light pipe could also be designed to provide direction control as well, to work like a directional spotlight.

Such lighting in a tank may be helpful not only in examining the condition of the tank with the robot, but also in maneuvering the robot within the tank. Robots typically move along the tank floor on wheels and the tank floor typically has sludge and even obstacles that can trap or encumber movement of the robot. A cleaning brush may be attached to the robot to clear the tank floor just ahead of the robot. A preferred such brush is a “mustache” type of brush, positioned at the front of the robot, and constructed from non-sparking materials, including for example brass bristles, an aluminum bracket and bronze screws for attachment. A more robust brush could be installed the length of the robot and even be provided with motive power off of one or more of the robot's drive wheels. Again, such a brush would need to be composed of non-sparking materials.

A remotely operable canister fitted to a pole or cable could be used to sample sludge and silt at the bottom of the tank, particularly in the area below the access hatch. A sampler could also be attached to the robot and the robot used to obtain a sample of the sludge on the tank bottom.

A weight, composed of non-sparking material such as bronze, for example, could also be installed on the belly of the robot to help keep the robot upright so that the robot can make use of its wheels and any brush attachment. Even heavy robots, weighing for example 200 lbs, are light in weight, for example about 35 lbs, when submerged in fluid in a tank, due to the inert gas in the robot housing. The robot weight may also be unevenly distributed making it easy for the robot to tip over, particularly if the tether or cabling is pulled in the wrong direction. Adding a weight on the belly of the robot provides a self-righting mechanism.

An inflatable float attached to the robot may also be used to help maneuver and/or recover the robot from the tank. Preferably, the operator should have the ability to inflate and deflate or control the inflation and deflation of the float during operation of the robot in the tank. Inflated, the float can lift the robot off the tank floor to clear any roof pillar braces or inlet piping located near the tank floor or to get the robot out of sludge or slump on the tank bottom. The float might also assist with freeing the robot from any cable entanglements. By lifting the robot off the tank floor, the weight of the robot is not tensioning the tether or cable and thus the robot is able to be moved about more easily by pulling on the tether or cabling.

Several methods could be used for inflating and deflating the float. One possible method uses an independent inert gas line to the float, and valving to inflate and deflate the float. When inflation is desired, the gas line is connected to a pressurized gas supply and the float is inflated. One example of a float that could work in this fashion is one comprised of a canvas bag with non-sparking snap closures enclosing an inner tube. Such a float might need for example about 10 psi over the external fluid pressure to open the bag and allow the float to expand.

A preferred method for inflating the float is to use the inert gas supply used to purge and pressurize the robot housing. A remotely operated valve, located in the robot housing, could be actuated from the control panels to allow the purge gas to enter the float through a short gas line from the housing. The purge gas pressure would then be raised to pop open the canvas bag and release the float.

Another method for inflating the float would be to use a relief valve from the robot's housing and inflate the float by over-pressurizing the robot to lift the relieve valve. Additionally, a remote gas cartridge, such as a carbon dioxide bottle for example, could be used to supply gas to the float.

The float must relieve internal pressure as it rises up from the tank floor allowing the gas inside to expand. Without this capability, the float would burst as it rises when the internal pressure becomes significantly higher than the outside pressure. Thus, a careful balance is needed between enough pressure to pop the float open and too much internal pressure, which could burst the float. A gas line to the float, which allows gas to move in and out of the float as needed, would afford this balance.

To best allow extraction through a restrictive tank hatch, the float preferably deflates remotely after a tank has been reeled in for removal from the tank. When using an independent gas line, an operator could lower the gas pressure by venting the line to deflate the float. When using internal purge and pressurization gas, an operator could either lower the purge gas pressure or close the inflation valve and open a separate deflation valve to release gas from the float. A second deflation valve in this case is preferred.

The utility of explosion proof robots, such as robot 10 illustrated in FIG. 1 for example, for inspecting a tank bottom in an atmospheric tank inspection is established, whether the tank is above ground or on a floating vessel. However, safety inspection of an above ground storage tank also includes the upper and lower roof seals on floating roof tanks. The lower seal is typically visually inspected from the underside after draining and cleaning the tank. A submersible explosion proof robot, such robot 10A illustrated in FIG. 2 for example, can be used to inspect the underside of a floating roof tank while the tank is still in service.

Such a submersible “swimmer” type robot 10A would preferably have the features of a robot for use in tank floor inspection with some modifications. That is, the robot 10A would have an inert gas purge and pressurization safety system to ensure the robot was explosion proof, as already described. The robot 10A would also be composed of non-spark producing materials. Additionally, robot 10A would preferably have side drive wheels 22 and side thrusters 23 to allow the robot to “hug” the tank wall, providing stable motion for an inspection camera. An infrared-sensitive pan and tilt camera 21A and lighting would be pointing up to inspect the floating roof lower seal, rather than down to inspect the tank floor.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of the patent application cited herein is hereby incorporated by reference, to the extent that it provides exemplary, procedural, or other details supplementary to those set forth herein.

I claim:

1. A method for safely inspecting an atmospheric storage tank without having to empty the tank, the method comprising:
providing an explosion proof robot;
purging the robot a plurality of times with an inert gas,
clearing any and all oxygen within the robot,
causing the pressure inside the robot to be greater than the pressure outside the robot;
placing the robot into the tank, maintaining the pressure within the robot greater than the pressure external the robot;
remotely operating the robot to observe the tank interior, maintaining the pressure within the robot greater than the pressure external the robot; and
retrieving the robot,
wherein the explosion proof character of the robot is assured by explosion proof design of the robot and by monitoring the pressure within and outside the robot throughout the inspection, such that operation of the robot will cease if the pressure within the robot falls below the pressure external the robot.

2. The method of claim 1 wherein the robot moves along the tank floor for observation of the tank floor using ultrasonic probes and sonar transducers.

3. The method of claim 1 wherein the robot has a camera and moves along the tank floor for observation of the tank floor using the camera.

4. The method of claim 1 wherein the tank has a floating roof, the robot has a pan and tilt camera and the robot hugs the tank wall for observation of the underside of the tank roof using the camera.

5. The method of claim 1 wherein the tank is illuminated with a light pipe for observation of the tank interior.

6. The method of claim 1 wherein the robot has mounted therein LEDs to illuminate the portion of the tank near the robot.

7. The method of claim 1 wherein the robot housing is made of one or more non-sparking materials selected from the group consisting of bronze, brass, aluminum, and plastic.

8. The method of claim 1 wherein the robot has an inflatable float tethered thereto and the float is inflated to lift or maneuver the robot away from obstacles in the tank.

9. The method of claim 1 wherein the tank floor has sludge thereon and the robot has at least one brush affixed thereto for sweeping away the sludge on the tank floor in the robot's path.

10. The method of claim 9 wherein the bush is affixed along the lower front of the robot and sweeps sludge on the tank floor in front of the robot's path.

11. The method of claim 9 wherein the brush is affixed the length of the underside of the robot and sweeps away sludge as the robot moves along the tank floor.

12. The method of claim 1 wherein the robot is weighted to stay upright.

13. The method of claim 1 wherein the storage tank is above ground.

14. The method of claim 1 wherein the storage tank is on a floating vessel.

15. The method of claim 1 further comprising providing a remotely operable canister fitted to a pole or cable; placing the canister into the tank to sample any sludge or sediment on the tank bottom; and removing the canister from the tank for analysis of any sludge or sediment collected.

16. A method for safely inspecting an atmospheric storage tank having a floating roof, without having to empty the tank, the method comprising:
providing a first explosion proof robot for inspecting the floor of the tank;
providing a second explosion proof robot for inspecting the seals of the floating roof;
purging each robot a plurality of times with an inert gas,
clearing any and all oxygen within each robot,
causing the pressure inside each robot to be greater than the pressure outside the robot;
placing the first robot into the tank with an inflatable float attached thereto, maintaining the pressure within the robot greater than the pressure external the robot;
remotely operating the first robot to observe the floor of the tank, maintaining the pressure within the robot greater than the pressure external the robot, and inflating the float and using the buoyancy it provides to the robot to help maneuver the robot around obstacles on the tank floor;
deflating the float and retrieving the first robot;
placing the second robot into the tank, maintaining the pressure within the robot greater than the pressure external the robot;
remotely operating the second robot to observe the seals of the floating roof, maintaining the pressure within the robot greater than the pressure external the robot;
deflating the float and retrieving the second robot;
wherein the explosion proof character of the robots is assured by explosion proof design of the robots and by monitoring the pressure within and outside the robots throughout the inspection, such that operation of the robots will cease if the pressure within the robots falls below the pressure external the robots.

17. The method of claim 16 wherein the first robot employs LED lights and an infrared camera mounted therein in observing the tank floor.

18. The method of claim 16 wherein the second robot employs LED lights and a pan and tilt camera mounted therein in observing the floating tank roof seals, and wherein the robot hugs the tank walls during the observation.
